(19) United States
(12) Patent Application Publication
(10) Pub. No.: US 2026/0075584 A1
(43) Pub. Date: Mar. 12, 2026

(54) REDUCED CAPABILITY NON-TERRESTRIAL DEVICE PAGING ACQUISITION

(71) Applicant: Dell Products L.P., Round Rock, TX (US)

(72) Inventor: Ali Esswie, Calgary (CA)

(21) Appl. No.: 18/827,098

(22) Filed: Sep. 6, 2024

(51) Int. Cl. H04W 68/02

(52) U.S. Cl. CPC H04W 68/02

(57) ABSTRACT

A radio network node, which may be a terrestrial node or a non-terrestrial node, may determine to implement network energy saving measures based on a determined energy parameter value being determined to violate a corresponding energy parameter criterion. The node may transmit to a user equipment a paging delegation indication indicative that, during a paging occasion delegation period, at least one lightly loaded source paging occasion associated with the user equipment is to be temporarily suspended and delegated to a target paging occasion that may not be associated with the user equipment. The node may sleep during a delegated source paging occasion and may broadcast a paging message directed to the user equipment via the target paging occasion. The user equipment may avoid waking up during the delegated source paging occasion and instead may monitor the target paging occasion for paging messages during the paging occasion delegation period.

### REFERENCE TO RELATED APPLICATION

The subject patent application is related to U.S. patent application Ser. No. ______, filed ______, and entitled “ADAPTIVE NON-TERRESTRIAL NETWORK PAGING” (docket no. 139679.01/DELLP1331US), the entirety of which application is hereby incorporated by reference herein.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise determining, by a radio network node comprising at least one processor, a first paging occasion group, comprising at least one first paging occasion, associated with a first user equipment group and delegating, by the radio network node, paging corresponding to the first paging occasion group to at least one second paging occasion corresponding to a second paging occasion group associated with a second user equipment group to result in delegated paging. The method may further comprise facilitating, by the radio network node, transmitting, to at least one user equipment associated with the first user equipment group, a paging delegation indication indicative that the at least one user equipment is to avoid monitoring the at least one first paging occasion and that the at least one user equipment is to monitor at least one of the at least one second paging occasion associated with the second user equipment group.

In an example embodiment, the method may further comprise entering, by the radio network node, a low-power state during the at least one first paging occasion. The low-power state may comprise suspending paging during the at least one first paging occasion, thus resulting in energy saving, but the radio network node may continue to perform other operations other than paging during the low-power state during the at least one first paging occasion.

In an example embodiment, the determining of the first paging occasion group may comprise analyzing at least one paging metric corresponding to at least one low usage paging occasion with respect to at least one paging occasion low usage criterion to result in at least one analyzed low usage paging occasion metric and determining that the at least one analyzed low usage paging occasion metric satisfies the at least one paging occasion low usage criterion. In an embodiment, the at least one paging occasion low usage criterion may be that the determining the first paging occasion group may be determining that at least one paging occasion corresponding to the first paging occasion group may be a least-used paging occasion. In an embodiment, the at least one paging occasion low usage criterion may be that the determining the first paging occasion group may be a least-used paging occasion group.

The at least one paging occasion low usage criterion may comprise at least one of: at least one paging occurrence count criterion, or at least one paging occurrence determining period during which at least one paging occurrence count is to be analyzed with respect to the at least one paging occurrence determining period. In an embodiment, the at least one paging occasion low usage criterion may accompany an energy parameter criterion to be used by the radio network node to determine to trigger a network energy saving mode operation, for example temporarily halting the at least one first paging occasions group or a paging occasion corresponding thereto, based on an energy parameter value corresponding to the radio network node being determined to satisfy the an energy parameter criterion.

In an example embodiment, the paging delegation indication may be indicative of a paging occasion delegation period during which the at least one user equipment is to monitor the at least one second paging occasion and during which the radio network node may operate a network energy saving operation that may comprise suspending paging with respect to the at least one first paging occasion group or a paging occasion corresponding thereto.

In an example embodiment, the transmitting of the paging delegation indication may be based on analyzing at least one energy parameter metric corresponding to the radio network node with respect to at least one energy parameter criterion to result in at least one analyzed energy parameter metric and determining that the at least one analyzed energy parameter metric violates the at least one energy parameter criterion.

The paging delegation indication may be transmitted via at least one downlink broadcast channel corresponding to the radio network node. The radio network node may be a non-terrestrial radio network node or a terrestrial radio network node.

In an example embodiment, the paging delegation indication may comprise at least one paging occasion group pattern indication indicative of at least one paging occasion group pattern that comprises at least one of the at least one second paging occasion.

The at least one paging occasion group pattern indication may be indicative of a number of the at least one second paging occasion that the at least one user equipment is to avoid monitoring during a paging delegation period during which the at least one user equipment is to monitor the at least one second paging occasion.

In an example embodiment, the method may further comprise facilitating, by the radio network node, receiving at least one paging message directed to at least one user equipment associated with the first user equipment group and facilitating, by the radio network node, transmitting, to the at least one user equipment to which the at least one paging message is directed via at least one of the at least one second paging occasion, the at least one paging message.

In another example embodiment, a radio network node may comprise at least one processor configured to process executable instructions that, when executed by the at least one processor, may facilitate performance of operations that may comprise analyzing at least one paging metric, corresponding to at least one first paging occasion of a first paging occasion group associated with a first user equipment group, with respect to at least one paging occasion low usage criterion to result in at least one analyzed paging metric. The operations may further comprise determining that the at least one analyzed paging metric satisfies the at least one paging occasion low usage criterion to result in at least one determined low usage paging occasion and delegating the at least one determined low usage paging occasion to at least one active paging occasion group associated with a second user equipment group to result in at least one delegated paging occasion. The operations may further comprise transmitting, to at least one user equipment associated with the first user equipment group, a paging delegation indication indicative that the at least one user equipment is to avoid monitoring the first paging occasion group and that the at least one user equipment is to monitor at least one paging occasion associated with the second user equipment group.

In an example embodiment, the at least one paging occasion low usage criterion may comprise at least one of: at least one paging occurrence count criterion, or at least one paging occurrence determining period during which at least one paging occurrence count is to be analyzed with respect to the at least one paging occurrence determining period.

In an example embodiment, the operations may further comprise entering a low-power state during the at least one determined low usage paging occasion.

In an example embodiment, the paging delegation indication may comprise at least one paging occasion group pattern indication indicative of at least one paging occasion group pattern that comprises at least one paging occasion corresponding to the at least one active paging occasion group.

In yet another example embodiment, a non-transitory machine-readable medium may comprising executable instructions that, when executed by at least one processor of radio network equipment, may facilitate performance of operations that may comprise receiving, from computing equipment associated with a core network, adaptive paging configuration information and analyzing at least one paging metric, corresponding to at least one first paging occasion of a first paging occasion group associated with a first user equipment group, with respect to at least one paging occasion low usage criterion to result in at least one analyzed paging metric, wherein the adaptive paging configuration information comprises the at least one paging occasion low usage criterion. The operations may further comprise determining that the at least one analyzed paging metric satisfies the at least one paging occasion low usage criterion to result in at least one determined low usage paging occasion and delegating the at least one determined low usage paging occasion to at least one active paging occasion group associated with a second user equipment group to result in at least one delegated paging occasion. The operations may further comprise transmitting, to at least one user equipment associated with the first user equipment group, a paging delegation indication indicative that the at least one user equipment is to avoid monitoring the first paging occasion group and that the at least one user equipment is to monitor at least one paging occasion associated with the second user equipment group.

In an example embodiment, the operations further comprise entering a low-power state during the at least one determined low usage paging occasion.

In an example embodiment, the transmitting of the paging delegation indication may be based on analyzing at least one energy parameter metric, or measured value, corresponding to the radio network equipment with respect to at least one energy parameter criterion to result in at least one analyzed energy parameter metric and determining that the at least one analyzed energy parameter metric violates the at least one energy parameter criterion, wherein the adaptive paging configuration information may comprise the at least one energy parameter criterion. For example, if a battery charge level falls below a battery charge criterion the battery charge criterion may be deemed as being violated, or if an energy consumption rate exceeds an energy consumption rate criterion the energy rate criterion may be deemed as being violated.

In an example embodiment, the operations may further comprise receiving at least one paging message directed to at least one user equipment associated with the first user equipment group and transmitting, to the at least one user equipment to which the at least one paging message is directed, the at least one paging message via the at least one paging occasion associated with the second user equipment group.

In an example embodiment, the paging delegation indication may be indicative of a delegation period during which the at least one user equipment is to monitor the at least one paging occasion associated with the second user equipment group. The operations may further comprise determining that the delegation period has expired. Based on the delegation period being determined to have expired, the operations may further comprise transmitting, to the at least one user equipment, a paging group resume indication indicative that the at least one user equipment is to resume monitoring the at least one paging occasion associated with the first user equipment group.

In an example embodiment, a method may comprise receiving, by at least one user equipment comprising at least one processor from a radio network node, at least one paging delegation indication indicative that the at least one user equipment is to avoid monitoring at least one first paging occasion corresponding to a first paging occasion group associated with the at least one user equipment and that the at least one user equipment is to monitor at least one second paging occasion corresponding to a second paging occasion group associated with a second user equipment group, wherein the at least one user equipment is excluded from the second user equipment group. Responsive to the at least one paging delegation indication, the method may comprise monitoring, by the at least one user equipment, the at least one of the at least one second paging occasion corresponding to the second paging occasion group.

The at least one paging delegation indication may be indicative of a delegation period during which the at least one user equipment is to monitor the at least one second paging occasion associated with the second user equipment group. The at least one paging delegation indication is transmitted via at least one downlink broadcast channel corresponding to the radio network node. The at least one paging delegation indication may be transmitted via at least one system information block (“SIB”) message. The radio network node may be a terrestrial radio network node or a non-terrestrial radio network node.

The at least one user equipment may be non-terrestrial capable (e.g., the user equipment is designed or configured to communicate with a non-terrestrial radio network node with respect to frequency, transmission power, timing, or other parameter that may be associated with radio communication with a satellite.

In an example embodiment, the at least one paging delegation indication may comprise at least one paging occasion group pattern indication indicative of at least one paging occasion group pattern that comprises at least one of the at least one second paging occasion. The at least one paging occasion group pattern indication may be indicative of a number of the at least one second paging occasion to avoid monitoring during a paging delegation period during which the at least one user equipment is to monitor the at least one second paging occasion.

In an example embodiment, the method may further comprise receiving, by the at least one user equipment, at least one paging message, directed to the at least one user equipment, via the at least one second paging occasion.

In an example embodiment, the method may further comprise determining, by the at least one user equipment, at least one paging detection reliability with respect to the at least one second paging occasion and analyzing, by the at least one user equipment, the at least one paging detection reliability with respect to at least one paging detection criterion to result in at least one analyzed paging detection reliability. Based on the at least one analyzed paging detection reliability being determined to violate the at least one paging detection criterion, the method may further comprise transmitting, by the at least one user equipment to the radio network node, at least one detection sensitivity failure indication to be indicative to the radio network node that the at least one user equipment failed to detect or failed to decode the at least one paging message.

The at least one detection sensitivity failure indication may comprise at least one of: at least one device identifier associated with the at least one user equipment, or at least one failed-occasion indication indicative of the at least one second paging occasion with respect to which the at least one user equipment failed to detect or decode the at least one paging message.

In another example embodiment, a user equipment may comprise at least one processor configured to process executable instructions that, when executed by the at least one processor may facilitate performance of operations that may comprise receiving, from a radio network node, a paging delegation indication indicative that the user equipment is to avoid monitoring at least one first paging occasion corresponding to a first paging occasion group associated with at least one user equipment and that the at least one user equipment is to monitor at least one second paging occasion corresponding to a second paging occasion group associated with a second user equipment group, wherein the second user equipment group does not comprise the user equipment. Based on the paging delegation indication, operations may further comprise monitoring at least one of the at least one second paging occasion.

In an example embodiment, the paging delegation indication may be indicative of a delegation period during which the at least one user equipment is to monitor the at least one second paging occasion associated with the second user equipment group. The delegation period may be determined by the radio network node based on a measured energy parameter value corresponding to the radio network node.

In an example embodiment, the paging delegation indication may comprise at least one paging occasion group pattern indication indicative of at least one paging occasion group pattern that comprises at least one of the at least one second paging occasion.

In an example embodiment, the operations may further comprise determining at least one paging detection reliability with respect to the at least one second paging occasion, wherein the at least one paging detection reliability corresponds to a number of attempts to decode at least one paging message transmitted via the at least one of the at least one second paging occasion and analyzing the at least one paging detection reliability with respect to at least one paging detection criterion to result in at least one analyzed paging detection reliability. Based on the at least one analyzed paging detection reliability being determined to violate the at least one paging detection criterion, the operations may further comprise transmitting, by the at least one user equipment to the radio network node, at least one detection sensitivity failure indication to be indicative to the radio network node that the at least one user equipment failed to detect or failed to decode the at least one paging message. At least one of the attempts to decode the at least one paging message may comprise attempting to blindly decode the at least one paging message.

In an example embodiment, the operations may further comprise receiving at least one paging message, directed to the user equipment, via the at least one second paging occasion.

In yet another example embodiment, a non-transitory machine-readable medium may comprise executable instructions that, when executed by at least one processor of a non-terrestrial capable user device may facilitate performance of operations that may comprise receiving, from a non-terrestrial radio network node, a paging delegation indication indicative that the non-terrestrial capable user device is to avoid monitoring at least one first paging occasion corresponding to a first paging occasion group associated with the non-terrestrial capable user device and that the non-terrestrial capable user device is to monitor at least one second paging occasion, corresponding to a second paging occasion group that does not comprise the non-terrestrial capable user device, according to at least one paging occasion group pattern that comprises the at least one second paging occasion Based on the paging delegation indication, the operations may further comprise monitoring at least one of the at least one second paging occasion. The operations may further comprise receiving at least one paging message, directed to the non-terrestrial capable user device, via the at least one second paging occasion.

In an example embodiment, the operations may further comprise determining at least one paging detection reliability with respect to the at least one second paging occasion, wherein the at least one paging detection reliability corresponds to a number of attempts to blindly decode at least one paging message transmitted via the at least one of the at least one second paging occasion and analyzing the at least one paging detection reliability with respect to at least one paging detection criterion to result in at least one analyzed paging detection reliability. Based on the at least one analyzed paging detection reliability being determined to violate the at least one paging detection criterion, the operations may further comprise transmitting, by the at least one non-terrestrial capable user device to the non-terrestrial radio network node, at least one detection sensitivity failure indication to be indicative to the non-terrestrial radio network node to change the at least one paging occasion group pattern.

### BRIEF DESCRIPTION OF THE DRAWINGS

FIG. 1 illustrates wireless communication system environment.

FIG. 2 illustrates an environment with a satellite base station/gateway and satellite that are capable of communication of traffic corresponding to a radio access network.

FIG. 3 illustrates an example environment with paging directed to a user equipment device of a user equipment group being delegated to paging occasions associated with a different user equipment group.

FIG. 4 illustrates example adaptive paging configuration information.

FIG. 5 illustrates example paging delegation indication information.

FIG. 6 illustrates example detection sensitivity failure indication.

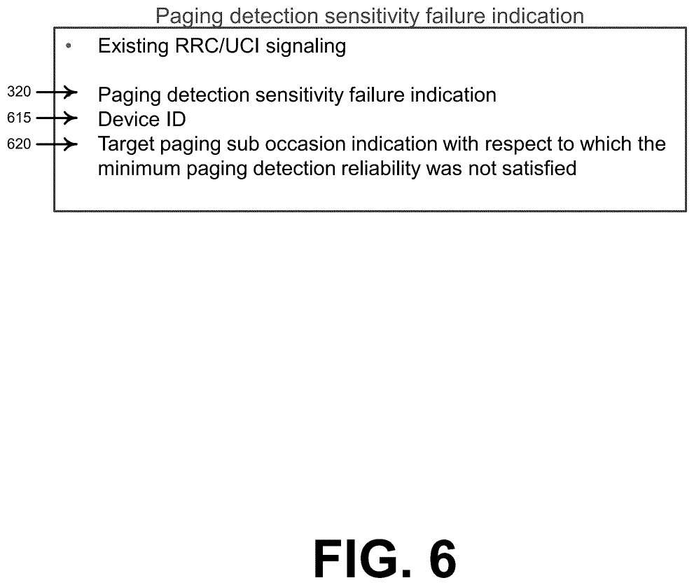

FIG. 7 illustrates example paging occasions associated with a user equipment group being deactivated and delegated to paging occasions associated with another user equipment group.

FIG. 8 illustrates a timing diagram of a radio network node delegating paging occasions.

FIG. 9 illustrates a timing diagram of a user equipment using delegated paging occasions to receive paging messages.

FIG. 10 illustrates a flow diagram of an example method to facilitate delegation of lightly used paging occasions to a paging occasion group comprising more heavily used paging occasions.

FIG. 11 illustrates a block diagram of an example method.

FIG. 12 illustrates a block diagram of an example radio network node.

FIG. 13 illustrates a block diagram of an example non-transitory machine-readable medium.

FIG. 14 illustrates a block diagram of an example method.

FIG. 15 illustrates a block diagram of an example user equipment.

FIG. 16 illustrates a block diagram of an example non-transitory machine-readable medium.

FIG. 17 illustrates an example computer environment.

FIG. 18 illustrates a block diagram of an example wireless user equipment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence (“AI”) and machine learning (“ML”) models may facilitate performance and operational functionality and improvements in 5G implementation, such as, for example, network automation, optimizing signaling overhead, energy conservation at devices, and traffic-capacity maximization. An artificial intelligence machine learning models (“AI/ML model”) functionality can be implemented and structured in many different forms and with varying vendor-proprietary designs. A 5G radio access network node (“RAN”) of a network to which the user equipment may be attached or with which the user equipment may be registered may manage or control real-time AI/ML model performance at different user equipment devices for various radio functions. Similarly, a user equipment or user device may use AI/ML to facilitate various functionality.

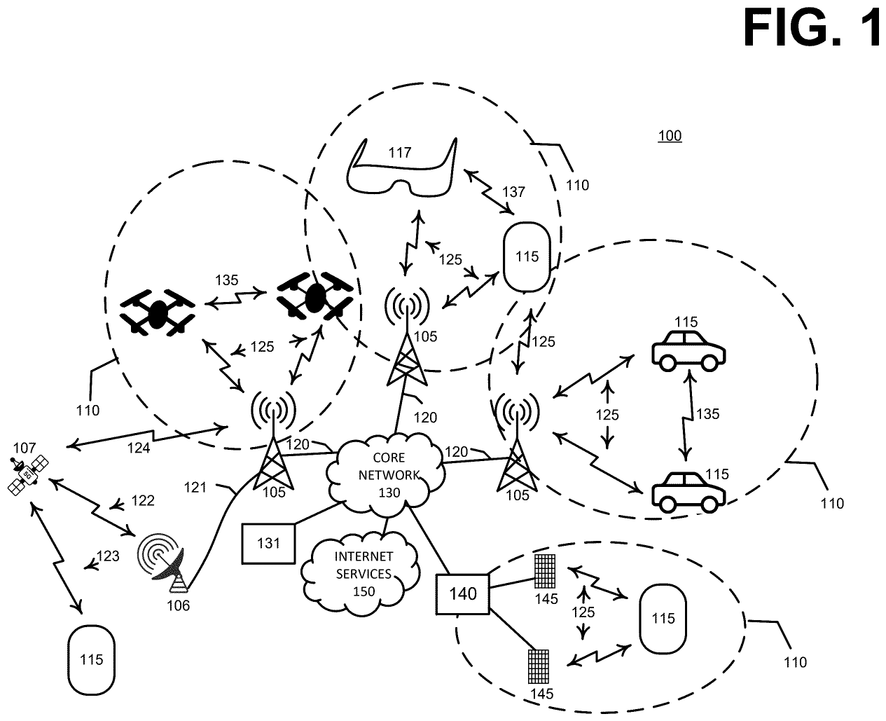

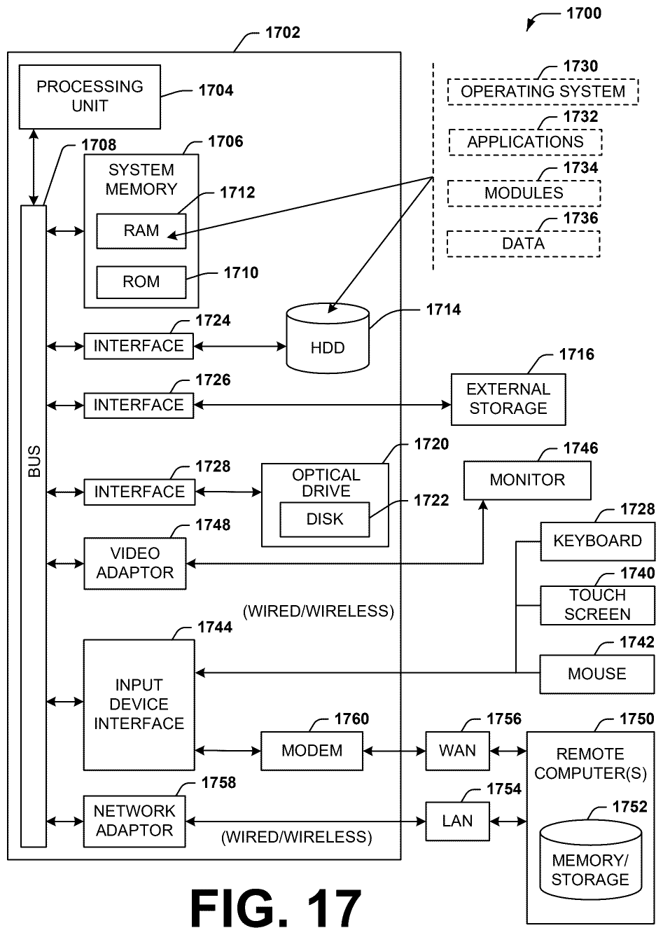

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 17.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The evolution of communication networks has witnessed remarkable advancements over the past decades. A significant extension of 5G's potential may lie beyond the conventional terrestrial infrastructure, giving rise to what are known as Non-Terrestrial Networks (“NTN”).

Non-Terrestrial Networks may encompass a diverse range of technologies and architectures that may comprise space-based, airborne, and maritime platforms to enhance global communication capabilities. Integration of 5G and non-terrestrial environments may facilitate connectivity being established, maintained, and optimized to remote and underserved regions.

Satellites equipped with 5G capabilities constitute an aspect of 5G NTN. Satellites, positioned in low Earth orbit (“LEO”), medium Earth orbit (“MEO”), or geostationary orbit (“GEO”), may form an intricate web of interconnected nodes. The satellites can provide widespread coverage, offering high-speed data connections, low latency communication, and global mobility. Satellites may facilitate broadband access in rural and remote areas, disaster-stricken regions, and on moving vehicles, ships, and aircraft, thus bridging the digital divide.

Satellite-based NTN can bridge connectivity gaps in remote and rural areas, provide disaster recovery communication, and offer enhanced coverage for maritime and aeronautical services. High-altitude platforms and drones equipped with cellular capabilities can serve as temporary network relays for events, emergencies, or areas with signal-strength coverage deficiencies, such applications may benefit not only traditional voice and data services but also for technologies, such as, for example, Internet of Things (“IoT”), wherein connectivity is typically a desirable, or a fundamental requirement.

A non-terrestrial base station 106, which may comprise a satellite antenna, may be coupled to core network 130. Non-terrestrial base station 106 may communicate with satellite 107, which may communicate with a user equipment 115. Non-terrestrial base station 106, which may be referred to as a non-terrestrial network gateway, and satellite 107 may facilitate delivering traffic corresponding to a radio access network, which may comprise RAN nodes 105, core network 130, backhaul links 120, and long-range wireless links 125, to user equipment that may be located beyond coverage of a RAN node 105. Links 121 between RAN nodes 105 and satellite base station/gateway 106 may comprise coaxial, fiber, or wireless links that may be similar to links 120. Links 122 and 124 to satellite node 107, and links 123 from satellite/node 107 to UE 115, may comprise line-of-sight microwave signal transmission. A UE 115 may be configured with at least one antenna, or at least one processor, to facilitate transmitting or receiving microwave signals to/from satellite node 107. Description herein of, or reference herein to, a radio node or a radio network node may be a description of or a reference to either a terrestrial RAN node 105, a non-terrestrial gateway 106, a non-terrestrial satellite node 107, or a combination of one or more of a terrestrial RAN node, a non-terrestrial gateway, or a non-terrestrial satellite. A terrestrial radio network node may be referred to as a “TN” node. Reference to a satellite node, or a non-terrestrial network node (“NTN node”), may comprise a reference to satellite 107, base station gateway 106, or a combination of satellite 107 and base station/gateway 106.

Core network 130 may comprise, or may be communicatively coupled with, shared core entity 131, which may be referred to as a shared core entity node or a shared core node. Shared core entity 131 may be associated with TN node 105 or NTN node 107 and may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

It will be appreciated that although an NTN node may benefit the most from embodiments disclosed herein, techniques disclosed herein may be of benefit to a ground-based RAN node. Thus, use of “radio network node” may be interpreted as referring to a ground-based RAN node or to a satellite node, which may comprise a gateway 106 or a satellite 107.

NTNs can enhance the limited coverage of ground RANs, which makes NTNs cost efficient in remote rural areas, mountainous areas, and generally where ground cellular deployments are either not possible or not cost efficient.

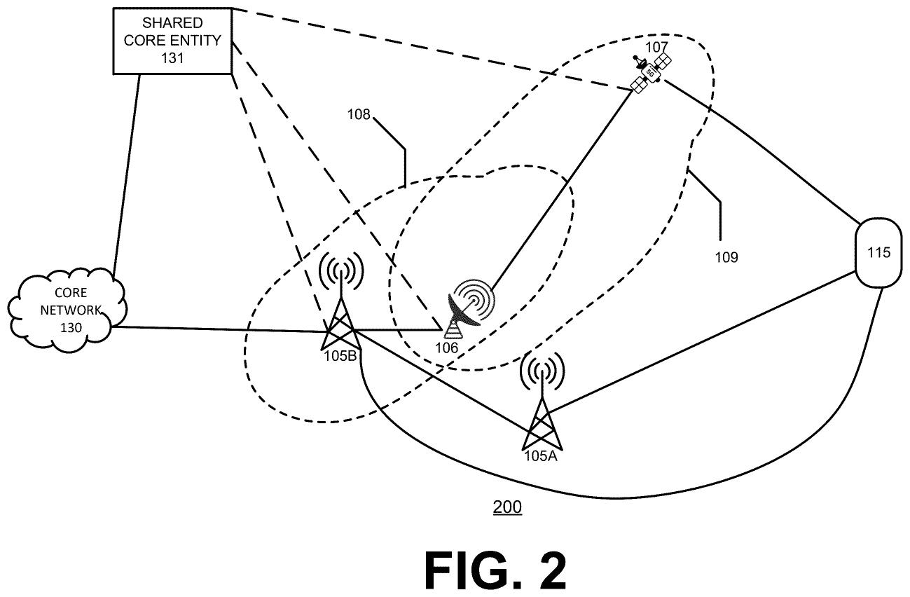

Turning now to FIG. 2, the figure illustrates ground-based RAN node 105, base station 106, and NTN node 107, any one or more of which may be referred to as a radio network node. In reference to some embodiments disclosed herein, reference to a TN node may comprise a reference to node 108, which may comprise one or more of terrestrial RAN node 105 or gateway 106. In reference to some embodiments disclosed herein, reference to an NTN node may comprise a reference to node 109, which may comprise one or more of gateway 106 or satellite 107. In some embodiments, a communication session with UE 115 may be served by RAN node 105. RAN node 105 may communicate directly with satellite node 107 via communication links 124 or via gateway 106 via links 121 and 122.

It may be desirable to implement gNodeB/RAN node functionality on board an NTN node/satellite node to serve user equipment. However, implementing RAN node functionality in an NTN node may give rise to performance limitations that may impact overall operation. For example, an NTN node implementing gNodeB functionality may consume energy at a rate similar to, or greater than, an energy consumption rate corresponding to a terrestrial RAN node due to providing similar functionality as the terrestrial node but providing the functionality to a potentially much larger number of user equipment because of a much wider coverage area corresponding to a non-terrestrial node with respect to a coverage area corresponding to a terrestrial node. Moreover, a non-terrestrial network node typically operates with a more limited energy source (e.g., a battery) as compared to an energy source corresponding to a terrestrial node (e.g., connection to a local electric power grid).

Therefore, it may be desirable to offload energy-consumption-heavy radio operations from an NTN node to a terrestrial node if power consumed by an NTN/satellite node is deemed excessive or poses a risk to the NTN node/satellite (e.g., tending to cause a dead battery at the NTN node). It may be desirable to facilitate controlling energy consumption of an NTN satellite node while offering full radio access network node functionality to user equipment devices.

A radio function that tends to consume a large amount of transmitter power is paging operation wherein an NTN RAN node facilitates broadcasting paging indications/requests/messages directed to a ground user equipment device indicative of an incoming message (e.g., indicative of an incoming call directed to the user equipment device located at or near the ground). Due to the significantly large coverage footprint of an NTN radio network node, NTN paging may present a problem of needing to broadcast multiple repetitions of a paging message via many NTN downlink beams thus imposing a high power consumption, or a high power consumption rate, on the NTN radio network node. To solve the problem of having to keep multiple paging occasions active for broadcasting of paging messages, embodiments disclosed herein may facilitate dynamic NTN paging relaxation wherein several paging occasions and corresponding resources (e.g., resources that may be monitored by one or more user equipment device groups) may be temporarily halted/suspended and re-assigned/combined, or delegated, to being broadcast via at least one paging occasion corresponding to another paging occasion group. According to example embodiments, broadcasting of delegated paging may be performed according to a preconfigured monitoring pattern.

Paging occasion adaptability disclosed herein may facilitate an NTN RAN transceiver sleeping/shutting down for extended periods during paging occasions corresponding to determined low usage such that a few paging messages that are estimated to be delivered via a user equipment device's default source paging occasion (which may be referred to as a source paging occasion) may be instead broadcast by a different destination paging occasion (which may be referred to as a target paging occasion) without significantly negatively affecting paging with respect to the target paging occasion due to the lower usage of the delegated source paging occasion(s). Thus, according to techniques disclosed herein, a RAN node, for example an NTN RAN node, may be able to increase energy saving by delegating low usage paging occasions to target paging occasions and entering a low power usage mode during the delegated source paging occasion(s).

According to example embodiments disclosed herein, user equipment corresponding to a source paging occasion group (e.g., a paging occasion group may comprise at least one source paging occasion to be delegated to a target paging occasion group comprising target paging occasions) may only experience a slightly reduced paging operation capability during a period that source paging occasions are delegated to target paging occasions corresponding to paging occasion resources corresponding to other user equipment devices, thus avoiding complete paging resource starvation with respect to user equipment corresponding to paging occasions that are temporarily halted or suspended. Temporarily halting/suspending paging via lightly-loaded/lightly-used paging occasions may be useful to facilitate a RAN node sleeping/shutting down for periods that overlap with paging occasions serving a low number of devices and effectively temporarily configuring those devices to monitor and receive paging occasions via other more heavily loaded paging occasions without overload the destination/target paging resources. Thus, according to embodiments disclosed herein, an NTN RAN node, for example, may achieve an energy saving when an NTN vehicle is low on energy (e.g., while a satellite battery has a charge parameter level that is below a configured energy parameter criterion) while not significantly reducing paging performance of an idle mode user equipment.

According to example embodiments disclosed herein, based on a paging delegation indication message received from a RAN node, a user equipment may dynamically override existing paging monitoring and detection protocol stack configuration information by monitoring and decoding, in real time, specially reassigned/delegated paging resources that may be indicated by the paging delegation indication message. According to example embodiments disclosed herein, idle mode user equipment devices may be able to dynamically receive paging indications via paging occasions that are different from default paging occasion resources according to a dynamically configured detection pattern. Accordingly, using embodiments disclosed herein, idle mode user equipment devices may be configured to support and facilitate novel, flexible (e.g., time variant), paging detection behavior.

According to conventional techniques, regardless of how many devices are paged per paging occasion and regardless of energy consumption at an NTN RAN node, all paging occasions are always active. In contrast, according to example embodiments disclosed herein, paging reassignment/delegation messages may be transmitted to user equipment indicative of at least one default paging occasion being temporarily suspended and delegated to at least one paging occasion according to another user equipment device during a paging delegation period.

According to conventional techniques, user equipment devices are configured to perform semi-static monitoring and detection of configured paging occasions such that devices always monitor and detect a certain paging occasion with a semi-static configured periodicity. Instead, according to example embodiments disclosed herein, a user equipment device may adopt more dynamic paging detection operation wherein configured original/default original paging occasions may be halted and the user equipment accordingly may monitor and detect, non-uniformly (e.g., according to a pattern), a subset of target paging occasions to which the default source paging occasions may be delegated.

### Adaptive Non-Terrestrial Network Paging.

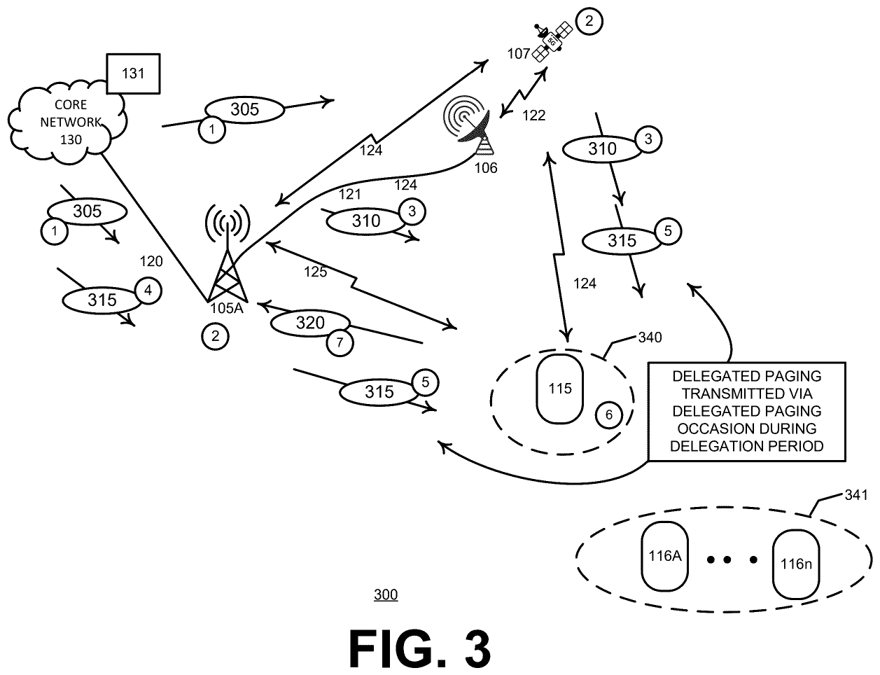

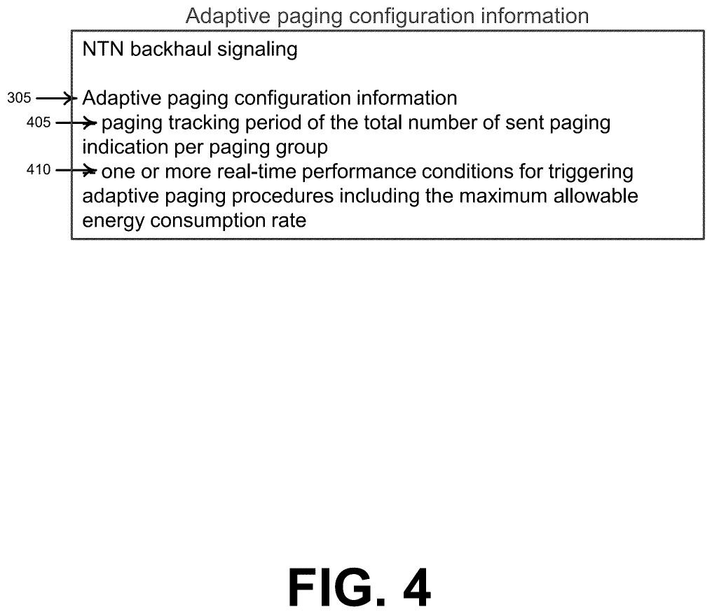

Turning now to FIG. 3, in an example embodiment, non-terrestrial network (“NTN”) RAN node 107 may receive at act 1 from ground gateway 106 and/or shared core network equipment component(s) 130 via backhaul microwave link(s) 122 or 124, adaptive paging configuration information 305. In an example embodiment, terrestrial RAN node 105 may receive information 305. As shown in FIG. 4. information 305 may comprise at least one of: a paging tracking period in field 405 indicative of a period during which sent paging messages are to be determined and in field 410 at least one real time performance condition criterion usable by RAN 105 or NTN node 107 to trigger adaptive paging procedures. A criterion indicated in field 410 may comprise an energy criterion, for example, a maximum allowable energy consumption rate or a minimum battery charge criterion at NTN node 107 or node 105. A paging tracking period indicated by field 405 may be a trailing time period during which NTN RAN node 107 or node 105 may track and count a total number of paging messages sent via each of at least one active paging occasion associated with a paging occasion group indicated by field 410. Paging tracking during a period indicated by field 405 may facilitate, when reduced capability paging is triggered, NTN RAN node 105/107 halting and dynamically reassigning/delegating at least one paging occasion that serves a fewest number of paging messages, a fewest number of user equipment devices, or fewer than a minimum number of user equipment devices, to avoid overloading a destination paging occasion to which source paging occasions are delegated. For example, if a paging occasion group associated with user equipment group 340, which comprises UE 115, facilitates fewer paging request than a criterion indicated in field 405 during a monitoring period indicated by field 405, paging occasions corresponding to paging the paging group associated with UE 115 may be assigned/delegated to paging occasions associated with a paging occasion group associated with user equipment group 341 that comprises user equipment 116A-116n.

At act 2, node 105 or 107 may track, calculate, or determine a current total number of paging indications transmitted thereby with respect to each of at least one paging group (e.g., the node determines a number of paging messages transmitted thereby via at least one paging occasion associated with each of at least one paging occasion user equipment group for example group 340 or group 341). Node 105 or 107 may analyze the determined number of paging messages transmitted via each of the paging occasions during a period indicated in field 405 of information message 305 to determine at least one low usage paging occasion (e.g., a paging occasion that has been used to transmit fewer paging messages than a paging message number that may be indicated via information 305).

Based on at least one performance condition indicated by field 410 in information message 305 for triggering adaptive paging, (e.g., a current energy consumption rate corresponding to node 107) being determined to exceed a criterion configured via field 410, NTN RAN node 107 or terrestrial node 105 may determine one or more current paging group with respect to which transmission of paging messages according there too is to be temporarily halted and re-assigned/delegated to other active paging groups, which may comprise more heavily used paging occasions. Thus node 105 or 107 may enter a low power state and avoid transmission of paging messages during a delegation period and may instead transmit paging messages, which would otherwise be transmitted via a delegated paging occasion, via a paging occasion corresponding to another paging occasion group. For example, if a paging occasion associated with paging occasion user equipment group 340 is being lightly used as determined at act 2, node 105 or node 107 may temporarily halt, or delegate, transmission of paging messages via the lightly used paging occasion such that paging messages directed to user equipment 115 are, during a paging delegation period, transmitted to user equipment 115 via at least one paging occasion that is associated with paging occasion user group 341 that comprises user equipment 116A-116n. User equipment 115 may monitor paging occasions corresponding to group 341 according to a paging group pattern. Thus, RAN node 105 or 107 may sleep/shutdown during a temporarily halted paging occasions since effectively the RAN node has logically moved the delegated paging occasions to other already-loaded paging occasions.

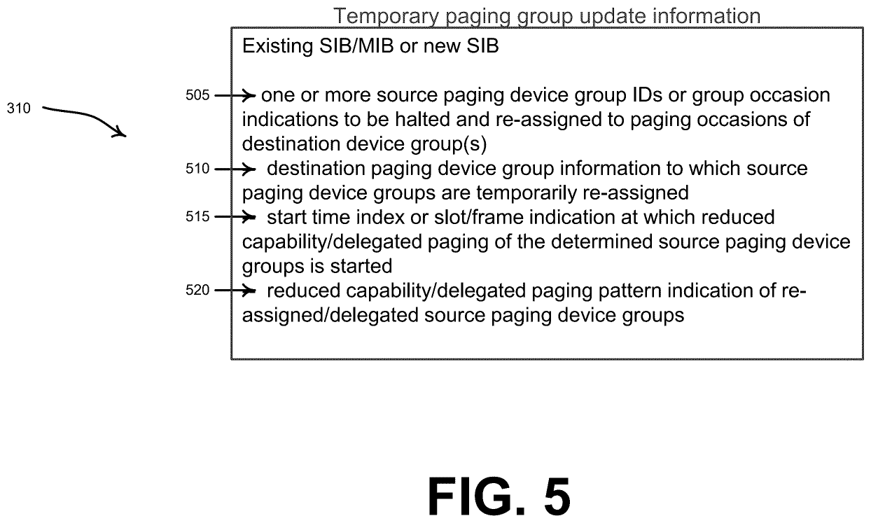

At act 3, NTN RAN node 107, or terrestrial node 105, may transmit, via a downlink broadcast channel, (e.g., the node may broadcast system information blocks), temporary paging group update information 310, which may be referred to as paging delegation indication information. As shown in FIG. 5, information 310 may comprise in field 505 one or more source paging device group indications, or identifiers, indicative of at least one source paging device group, or source paging occasions corresponding thereto, to be halted and re-assigned/delegated to at least one target paging occasion corresponding to at least one target destination paging group indicated by field 510. Information 310 may comprise in field 515 a delegation period start time index, a slot/frame indication, or an indication of another time parameter, with respect to which reduced-capability/delegated paging (e.g., a low usage paging occasion determined at act 2) is to start/begin. Information 310 may comprise, in field 520, a reduced capability paging pattern of re-assigned/delegated paging occasions, wherein user equipment corresponding to a paging occasion group with respect to which configured paging occasions indicated in field 505 have been delegated to paging occasions indicated by field 510 is/are to monitor at least one paging occasion corresponding to occasions indicated by field 510 according to a pattern, indicated by field 520, of the occasions indicated by field 510. For example, a pattern indication indicated by field 520 may comprise an indication of an offset of ‘2’ occasions indicative that a user equipment, corresponding to a paging occasion group with respect to which paging occasions have been delegated to at least one paging occasion indicated by field 510, is to monitor every other two paging occasions of the destination device paging group occasions indicated by field 510 during a delegation period indicated by field 515. After a period indicated by field 515 expires, original paging occasions indicated by field 505 may be re-activated. Thus, by notifying user equipment, or announcing to user equipment, that node 105 or node 107 has triggered reduced capability paging of one or more paging device groups such that user equipment devices act according to information indicated by information 310, (e.g., user equipment devices affected by delegated paging occasions indicated by field 505 monitor paging occasions indicated by field 510 according to monitoring pattern indicated by field 520 instead of their normally configured/original paging occasions). Information indicated by fields 505 and 510 may represent a list of impacted/affected source paging occasions (occasions indicated by field 505 that are to be temporarily halted) and a list of destination paging occasion(s), indicated by field 510, that are to be used to deliver paging messages to user equipment corresponding to the halted source paging occasions. Information indicated by field 520 may be indicative of a pattern of destination paging occasions indicated by field 510 that user equipment corresponding to the halted source paging occasions indicated by field 505 should monitor during a period indicated by field 515. Such a pattern indicated by field 520 may indicate that not every destination paging occasion indicated by field 510 carries paging messages 315 directed to user equipment devices corresponding to source paging occasions indicated by field 505, but that only a subset of destination paging indications indicated by field 510 may be used to deliver paging messages directed to user equipment corresponding to paging occasions indicated by field 505. For example, a monitoring pattern of ‘3’ may be indicative that user equipment devices corresponding to source paging occasions indicated by field 505 should expect to receive (and thus should always monitor) paging messages every third destination paging occasion indicated by field 510.

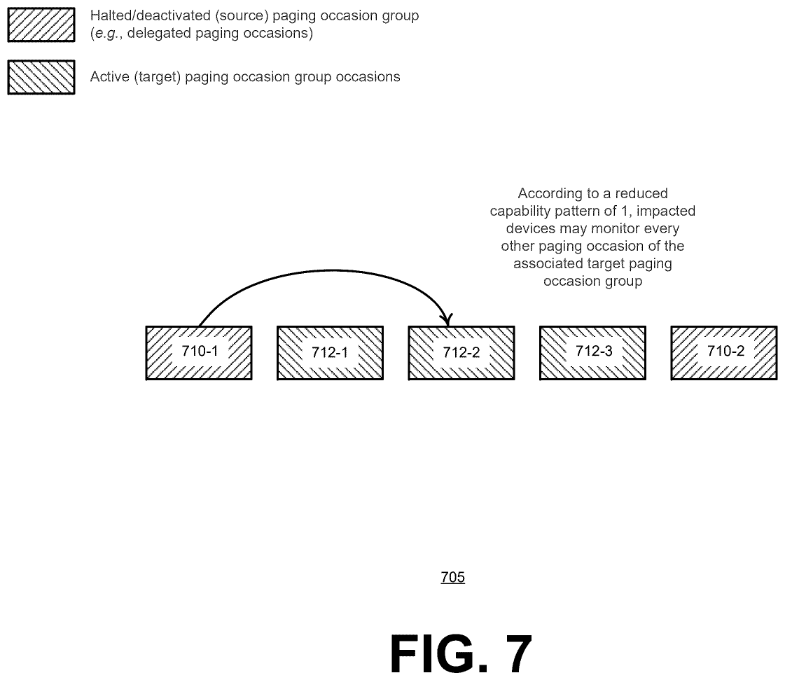

At act 4, during an active period of a reduced capability paging of one or more source paging device groups as determined by node 105 or 107, NTN RAN node 107 or terrestrial node 105 may receive and buffer a paging indication/message 315 directed to a user equipment device that corresponds to a source paging occasion device group indicated by field 505 (e.g., the paging message may be directed to UE 115 that may corresponding to group 340), and may transmit such received paging message(s) 315 via a next available paging occasion corresponding to a destination paging device group indicated by field 510 according to a reduced capability paging pattern indicated by field 520. Accordingly, NTN RAN node 107, or terrestrial node 105, during an active period of halting one or more of source paging occasions as indicated by field 515, may buffer received paging indications/message directed to one or more user equipment devices corresponding to paging occasions indicated by field 505 and may instead transmit the received paging messages via at least one target paging occasion indicated by field 510 according to a pattern indicated by field 520. In an example embodiment illustrated by FIG. 7, field 520 may indicate a reduced capability pattern of ‘1’, according to which a user equipment that may be configured to normally monitor default/source paging occasions 710, which may be delegated as indicated by field 505, may instead monitor paging occasions 712 as indicated by field 510 during a period indicated by field 515. Based on a reduced capability pattern of ‘1’ indicated by field 520, user equipment may monitor every other paging occasion 712. Thus, as shown in FIG. 7, instead of monitoring paging occasion 710-1 a user equipment may skip paging occasion 712-1 and instead monitor paging occasion 712-2. A node may indicate an occasion skipping pattern to avoid overloading a target paging occasion, for example occasion 712-1, with paging messages that would normally be delivered via a delegated source paging occasion. For example, if paging occasion 712-1 is typically more heavily loaded than paging occasion 712-2, by skipping delegation of paging occasions 710 during paging occasion 712-1, loading of paging occasions 712 may be balanced to avoid overlading an already heavily loaded occasion 712-1.

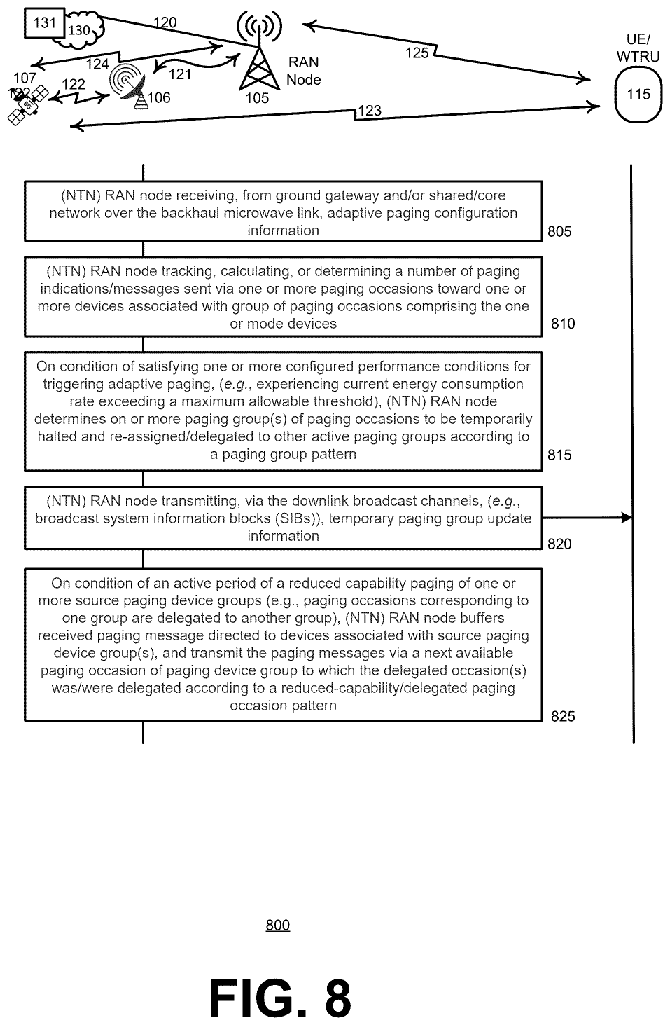

Turning now to FIG. 8, the figure illustrates a timing diagram of an example method 800. At act 805, non-terrestrial network RAN node 107 may receive, from ground gateway and/or shared core network equipment via backhaul microwave link(s), adaptive paging configuration information, for example information 305 described in reference to FIG. 3. The adaptive paging configuration information may comprise at least one of: at least one paging tracking period indication indicative of a period during which NTN node 107 may determine a number, or count, of paging indications/messages, per paging group, broadcast by the NTN node during a configured period. The adaptive paging configuration information may comprise at least one real-time performance condition criterion usable to trigger adaptive paging procedures. For example, a real time performance condition criteria may comprise an energy parameter criterion, for example, a maximum allowable energy consumption rate corresponding to energy consumption by NTN node 107. At act 810, NTN RAN node 107 may track, calculate, and/or determine a current total number of paging indications/message broadcast by the NTN ran node to user equipment via each of at least one paging device group corresponding to at least one paging occasion group during a period indicated at act 805. For example, NTN RAN node 107 may determine a number of paging messages transmitted via paging occasions corresponding to a paging occasion group associated with paging occasion device group 340 shown in FIG. 3 and the NTN RAN node may determine another number of paging messages transmitted via paging occasions corresponding to a paging occasion group associated with paging occasion device group 341.

At act 815, NTN RAN node 107, based on the determination that one or more performance conditions to trigger adaptive paging configured at act 805 have been satisfied, (e.g., the NTN node is experiencing an energy consumption rate that exceeds a maximum allowable energy consumption rate threshold/criterion configured at act 805), the NTN RAN node may determine one or more currently active source paging group occasions corresponding to UU 115 to be temporarily halted and re-assigned/delegated to other active paging groups, which may correspond to other user equipment or which may not correspond to UE 115. NTN node 107 may also determine at act 815 at least one paging group pattern to be applicable to paging occasions associated with the other paging group(s) to which the temporarily halted delegated source paging occasion(s) are to be delegated. At act 820, NTN RAN node 107 may transmit, via downlink broadcast channel(s), (e.g., broadcast system information blocks), temporary paging group update information, for example a paging delegation indication message 310 described in reference to FIG. 3. A paging delegation indication message may comprise at least one of: at least one source paging device group identifier indicative of at least one source paging occasion group, or paging occasions corresponding thereto, to be halted and re-assigned/delegated to paging occasions corresponding to at least one destination, or target, device group paging occasion group. A paging delegation indication message may comprise at least one destination/target paging device group identifier or indication indicative of at least one destination/target paging occasion group, or at least one paging occasion corresponding thereto, to which the at least one indicated source paging occasion group, or at least one source paging occasion group corresponding thereto, is to be temporarily re-assigned/delegated. A paging delegation indication message may comprise at least one time value indication indicative of a delegation period during which at least one source paging occasion is to be delegated to at least one target paging occasion. The at least one time value indication may comprise at least one start time index or slot/frame indication during which the reduced capability/delegated paging of the determined source paging device group paging occasion(s) is to be started or to be implemented, or the at least one time value indication may comprise at least one expiration time at which a delegation period of delegated paging may expire. A paging delegation indication message may comprise at least one reduced-capability paging occasion delegation paging pattern indicative of a pattern according to which user equipment corresponding to, or associated with, delegated source paging occasions are to monitor or attempt to decode target paging occasions to which the temporarily halted/suspended source paging occasions have been delegated. For example, a paging delegation indication may comprise an offset value of ‘2’ to indicate that user equipment corresponding to a re-assigned/delegated source paging device group are to monitor every other two paging target paging occasions corresponding to a destination/target device paging groups. A paging delegation indication message may comprise at least one time value indication indicative of an expiration time of the paging delegation period, for example, the paging delegation indication message may comprise an end time indication or a total active time indication corresponding to the delegation period during which at least one source paging occasion is to be delegated to at least one target paging occasion. After implementation of the paging delegation period, original source paging occasions corresponding to a source paging device group may be re-activated. Reactivation of delegated source paging occasions may be based on a determined energy parameter value corresponding to NTN RAN node 107 being determined to satisfy an energy parameter criterion (e.g., a battery charge value corresponding to a battery charge associated with NTN RAN node 107 may equal or exceed a configured battery charge criterion to be used to determine to trigger paging occasion delegation).

Based on a determination to implement delegation of at least one source paging occasion to at least one target paging occasion, at act 825 NTN RAN node 107 may buffer received paging indications/paging messages (e.g., paging messages 315 illustrated in FIG. 3) directed to any user equipment device corresponding to a source paging occasion, or source paging occasion group, indicated by the paging delegation indication message transmitted at act 820, and may transmit a buffered paging message via a next available paging occasion, which may be determined based on an indicated paging occasion delegation pattern corresponding to a paging occasion group with respect to which paging delegation is indicated by the paging delegation indication message.

### Reduced Capability Non-Terrestrial Device Paging Acquisition.

As described in reference to FIG. 3, NTN capable WTRU 115 (e.g., a user equipment device capable of communication with an NTN/satellite node with respect to frequency, timing, or transmission power) may at act 3 receive, download broadcast radio signaling, from an TN RAN node 105, or from NTN RAN node 105, selected by the WTRU during idle state operation, temporary paging group update information 310 described above and as shown in FIG. 5.

Based on having received information message 310, NTN-capable WTRU 115 may determine whether its own device paging group (e.g., group 340) is indicated by information included in message 310 as a paging device group corresponding to paging occasions to be halted during a delegation period indicated by message 315. Based on determining that group 340 is indicated by field 505 of message 310, WTRU 115 may determine, based on information indicated by message 310, at least one destination/target paging device group (e.g., group 341 may be indicated by field 510) and may temporarily override the WTRU's original/configured paging group information (e.g., WTRU 115 may override configuration information that configures the WTRU to monitor default paging occasions corresponding to a paging occasion group corresponding to device group 340) and may instead monitor paging occasions corresponding to device group 341 if paging occasions corresponding thereto are indicated as target paging occasions by information 310.

Idle mode device 115, upon determining that its original paging occasion(s) is/are temporarily halted/suspended, may determine at least one target/destination paging occasion/group, and a corresponding pattern thereof, to monitor for paging messages 315 transmitted by RAN node 105 or 107 at act 4, during a paging delegation period indicated by field 515 of information 310. On condition of a reduced-capability/delegation period being indicated by information 310, WTRU 115 may monitor and perform blind decoding of target paging occasion(s), indicated by field 510, at act 4. WTRU 115 may monitor target paging occasions according to a pattern indicated by field 520. Thus, WTRU device 115 may effectively, temporarily, override its default paging behavior (e.g., default paging occasion and timing information that may have been configured when WTRU selected NTN RAN node 107 or TN node 105) with real-time configured paging resources and occasions corresponding to target occasion indications indicated by field 510. The actual paging occasion monitoring behavior of idle mode WTRU device 115 may be dynamic such that the WTRU only monitors a destination paging occasion subset the monitoring pattern configured via field 520. On condition of expiration of a reduced-capability/paging delegation period, WTRU 115 may assume/resume paging monitoring and decoding operations according to a default paging configuration.

Upon receiving a temporary paging update information via information 310, user equipment corresponding to paging occasions indicated as being delegated by field 505 may monitor target/destination paging occasions indicated by field 510 according to the configured delegated paging monitoring pattern indicated by field 520 and the user equipment may blindly decode the target paging occasions. However, due to an increased device multiplexing order with respect to a target/destination paging occasion, (e.g., an increased number of devices may be monitoring a paging occasion due to paging occasion delegation) and potentially an increase in a number of paging indications/messages transmitted via a paging occasions indicated by field 510, paging detection reliability may degrade below a minimum needed level for which a receiving user equipment device's sensitivity can facilitate decoding. Reduced paging detection reliability may effectively prevent user equipment for which normally configured paging occasions have been delegated from successfully receiving paging indications/messages according to a paging indication indicated by field 510. Accordingly, when a user equipment device that monitors a configured target paging occasion indicated by field of 510 may determine at act 6 a paging detection reliability/sensitivity value that is equal to or lower than a device-specific sensitivity threshold corresponding to the user equipment device, the user equipment device may trigger transmitting, at act 7, a paging detection sensitivity failure indication 320. Indication 320 may comprise in field 615 a device identifier associated with the user equipment device or in field 620 a target paging occasion indication indicative of a target paging occasion, which may be indicated by field 510 in information message 310, with respect to which the minimum paging detection reliability failed to satisfy a device specific sensitivity threshold.

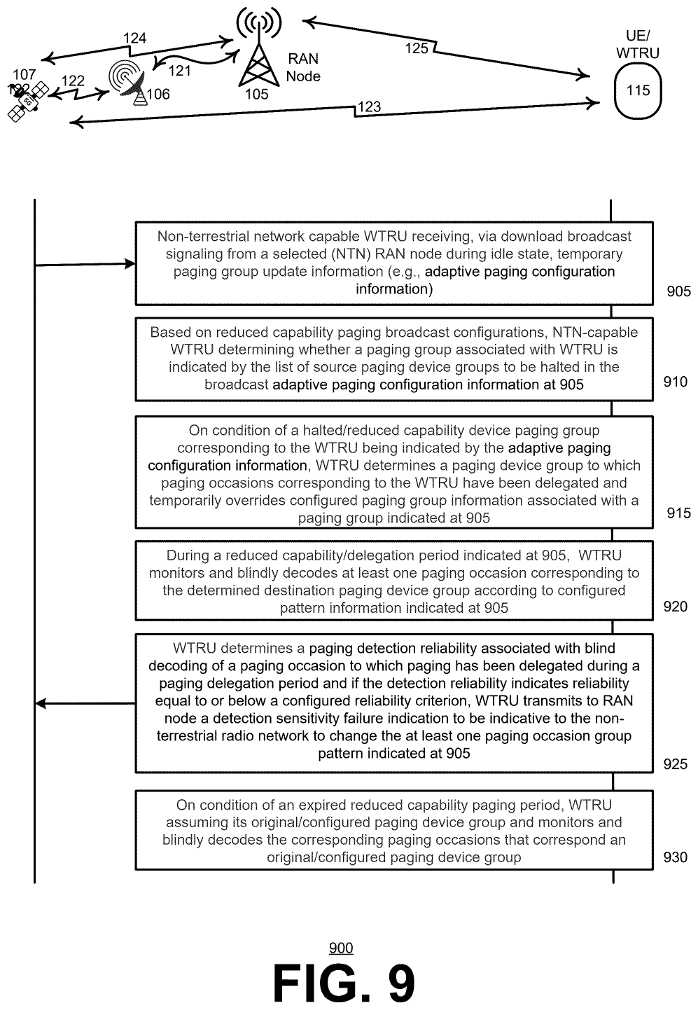

Turning now to FIG. 9, the figure illustrates a timing diagram of an embodiment method 900. At act 905, NTN-capable WTRU 115 may receive, via download broadcast signaling from selected NTN RAN node 107 during idle state operation, temporary paging group update information (e.g., information 310 described in reference to FIGS. 3 and 5). On condition determining information 310 having been received at act 905, at act 910 NTN WTRU 115 may determine whether the WTRU's device paging group is indicated by a list, included in field 505 of the information received at act 905, indicative of source paging device groups to be halted. At act 915, on condition of halted/reduced-capability WTRU device paging group indicated by field 505 (e.g., information 310 indicates in field 505 group 340 illustrated in FIG. 3 that may comprise WTRU 115), WTRU 115 may determine a destination/target paging occasion device group (e.g., group 341) indicated by field 510 and may temporarily override configured default paging group information with determined target device paging group occasions indicated by field 510.

At act 920, based on having determined a reduced-capability paging delegation period indicated by information 310 received at act 905, WTRU 115 may monitor and perform blind decoding of at least one paging occasion indicated by field 510 of information 310 according to a monitoring pattern indicated by field 520. At act 925, WTRU 115 may determine a paging detection reliability associated with blind decoding of a paging occasion to which paging has been delegated during a paging delegation period and if the detection reliability indicates reliability equal to or below a configured reliability criterion, the WTRU may transmit, to NTN RAN node 117 a detection sensitivity failure indication (e.g., message 320) to be indicative to the non-terrestrial radio network node to change the at least one target paging occasion group pattern indicated by field 520 in information 310 received at act 905. On condition of an expired reduced capability paging period, which expiration time may be indicated by information 310, WTRU 115 may, at act 930, resume paging occasion and monitoring according to configured default paging occasion information.

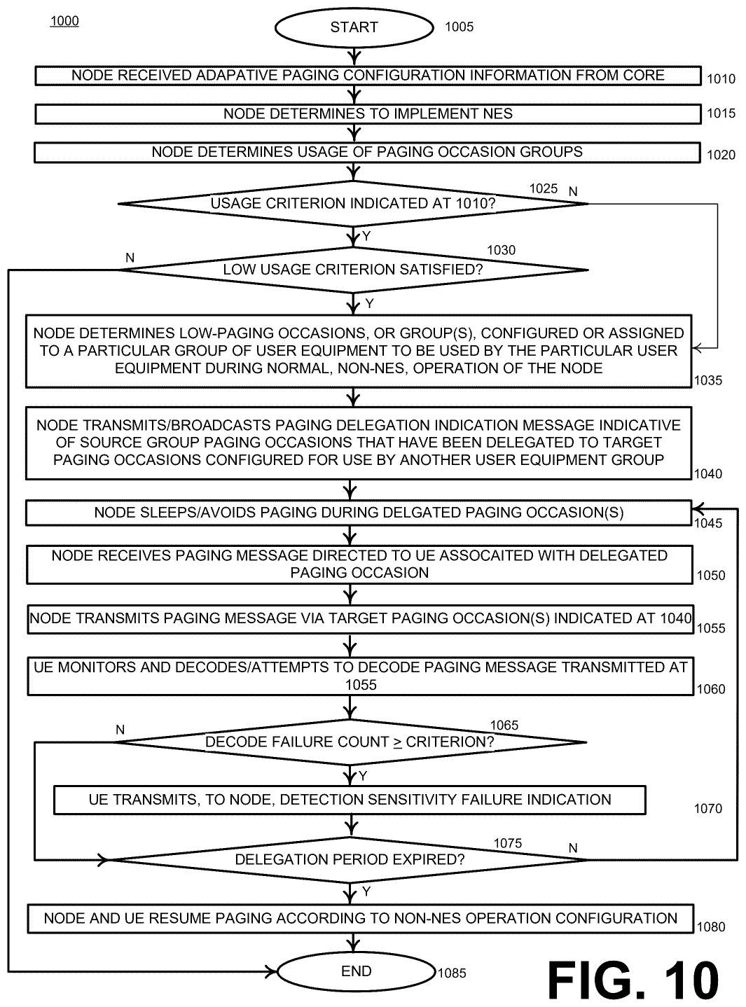

Turning now to FIG. 10, the figure illustrates a flow diagram of an example method 1000. Method 1000 begins at act 1005. At act 1010, a node for example a non-terrestrial node 107 or terrestrial node 105 as described in reference to FIG. 1, may receive from core network equipment corresponding to core network 130 adaptive paging configuration information, for example information 305 described in reference to FIG. 3. At act 1015, the node may determine to implement a network energy saving procedure to deactivate paging of at least one idle mode user equipment during at least one paging occasion configured to be used by the at least one idle mode user equipment. A determination made at act 1015 may be based on analysis of an energy parameter value corresponding to the node with respect to an energy criterion, which may be included in the information received at act 1010.

At act 1020, the node may determine usage of at least one paging occasion corresponding to at least one paging group, which may be associated with a particular group of user equipment devices. For example one or more paging occasions corresponding to a first group of paging occasions may be lightly used because the paging occasion group is assigned to a small number of user equipment devices or because the user equipment that are assigned to the paging occasion group are not frequently paged, for example if the user equipment are machine to machine devices, extended reality appliances, or devices executing applications that typically are not frequently paged.

At act 1025, the node may determine whether information received at act 1010 comprises a paging occasion usage criterion. If a determination made at act 1025 is that information received at act 1010 does not comprise a paging occasion usage criterion, method 1000 may advance to act 1035. If a determination is made at act 1025 that information received at act 1010 comprises a usage criterion, method 1000 advances to act 1030. At act 1030, the node may determine whether a low usage criterion indicated by information received at act 1010 is satisfied. If a determination is made at act 1030 that a low usage criterion is not satisfied method 1000 advances to act 1085 and ends.

Returning to description of act 1035, the node may determine at least one low-usage, or a lowest-usage, paging occasion(s), or at least one low-usage or at least one lowest-usage paging occasion group, that may be configured to or assigned to a particular user equipment or to a particular group of user equipment and that is to be used by the particular user equipment/group during normal, non-network energy saving mode operation by the node. A determination that a paging occasion, or a paging occasion group, is low-usage or lowest-usage may be based on comparison of each of multiple paging occasions or multiple paging occasion groups that the node is configured to use to facilitate transmission of paging messages to user equipment corresponding to, or assigned to use, the paging occasion(s) or paging occasion group(s). For example, if a particular paging occasion, or at least one paging occasion corresponding to a particular paging occasion group, is used once per hour to broadcast paging messages to user equipment configured to use the particular paging occasion or particular paging occasion group, the node may determine, or deem, the particular paging occasion or particular paging occasion group to be a low-usage or lowest usage paging occasion/group.

At act 1040, the node may transmit or broadcast a paging delegation indication message, for example message 310 described in reference to FIG. 3, which may be received user equipment corresponding to, or associated with, the at least one paging occasion or at least one paging occasion group deemed to be low usage at act 1035. A paging delegation indication may be indicative of at least one paging occasion or paging occasion group associated with the at least one particular user equipment/user equipment group to be delegated to at least one other paging occasion or at least one other paging occasion group associated with another user equipment/user equipment group, wherein the particular user equipment/group is not configured to use the other paging occasion or paging occasion group to receive paging messages. Paging occasions or paging occasion groups that are indicated as being delegated to another paging occasion or paging occasion group may be referred to as first, or source, paging occasions or first/source paging occasion groups and the other paging occasion or paging occasion groups to which the source paging occasions or source paging occasion groups are delegated may be referred to as second, or target, paging occasions or second/target paging occasion groups. A paging delegation indication message transmitted at act 1040 may comprise a paging delegation duration indication indicative of a paging delegation period during which at least one source paging occasion, or source paging occasion group, is to be delegated to a target paging occasion, or a target paging occasion group. A paging delegation indication message may comprise a reduced capability/delegation paging pattern that may be indicative of paging occasions corresponding to a target paging occasion group to be monitored by a user equipment with respect to which source paging occasions corresponding thereto have been delegated to a target paging occasion group.

After determining at act 1015 to implement network energy saving measures and after transmitting at act 1040 a paging delegation indication message, at act 1045 the node may enter a sleep mode or a low power usage mode during a delegated paging occasion and may avoid performing paging operations during a delegated paging occasion. Instead, if a paging message is received by the node to be delivered to a user equipment via a delegated paging occasion during an active paging delegation period, the node may buffer the paging message and may transmit/broadcast the buffered paging message toward a user equipment to which the buffered paging message is directed during a next available target paging occasion. A next available target paging occasion may be determined based on a paging pattern indicated in the paging delegation indication message transmitted by the node at act 1040. A next available, or next configured, target paging occasion may not necessarily be a target paging occasion scheduled to occur as a next paging occasion after a delegated/source paging occasion if a paging pattern indicated by paging delegation indication message indicates that the user equipment is to skip one or more target paging occasions. Accordingly, the node may transmit at act 1055 a buffered paging message via a next available/next configured target paging occasion that may be determined based on a delegation paging pattern indicated in a paging delegation indication message transmitted at act 1040, and an idle mode user equipment to which the buffered paging message is directed may, at act 1060, based on having received a paging delegation indication message transmitted by the node at act 1040, wake up during a target paging occasion according to a delegation paging pattern and attempt to decode a target paging occasion transmitted by the node at act 1055. If at act 1060 the user equipment successfully monitors and decodes a paging message transmitted at act 1055 via a target paging occasion, the user equipment may act, or react, in response to the paging occasion message (e.g., the user equipment may enter an active mode and may receive an incoming call or may receive an incoming message or data packet from the node). If the user equipment does not successfully decode a paging message transmitted at act 1055 the user equipment may generate a count value, or may increment a counter, corresponding to, and indicative of, a number of unsuccessful, or failed, attempts at decoding a paging message.

At act 1065, the user equipment may determine whether a cumulative number of unsuccessful or failed decoding attempts equals or exceeds a configured detection sensitivity criterion. If a determination made at act 1065 is that a number of decode failures does not equal or exceed a configured detection sensitivity criterion method 1000 advances to act 1075. If, however, the user equipment determines at act 1065 that a cumulative number of unsuccessful or failed decoding attempts equals or exceeds a configured detection sensitivity criterion method 1000 advances to act 1070 and the user equipment may transmit to the node a detection sensitivity failure indication. The node may use a detection sensitivity failure indication transmitted by the user equipment at act 1070 to determined to delegate a source paging occasion to a different target paging occasion that may not be as heavily used, and thus may result in fewer decoding attempt failures by the user equipment than resulted from delegating paging message being delivered via the at least one target paging occasion that the user equipment attempted to decode at act 1060 that resulted in the number of decode attempt failures that equaled or exceeded a criterion at act 1065. After the user equipment transmits to the node a detection sensitivity failure indication at act 1070 method 1000 advances to act 1075.

At act 1075, if a delegation period indicated by a paging delegation indication message transmitted at act 1040 has not expired, method 1000 returns to act 1045. At act 1045 the node may remain in a sleep state, or low power state, during a delegated source paging occasion and may avoid paging operations during a delegated source paging occasion, and the user equipment may continue avoiding waking up during a configured and delegated source paging occasion and instead may wake up during a target paging occasion to attempt to decode and receive paging messages transmitted/broadcast by the node. If a determination is made at act 1075 that a delegation period indicated by a paging delegation indication message transmitted at act 1040 has expired, method 1000 advances to act 1080 and the node and the user equipment may resume paging according to a non-network energy saving operation configuration (e.g., the node may wake up and transmit paging messages during a default source paging occasion that was previously delegated and a user equipment configured to use the source paging occasion may revert to waking up during the source paging occasion and avoid waking up during a target paging occasion to potentially receive paging messages transmitted/broadcast by the node). Method 1000 advances to act 1085 and ends.

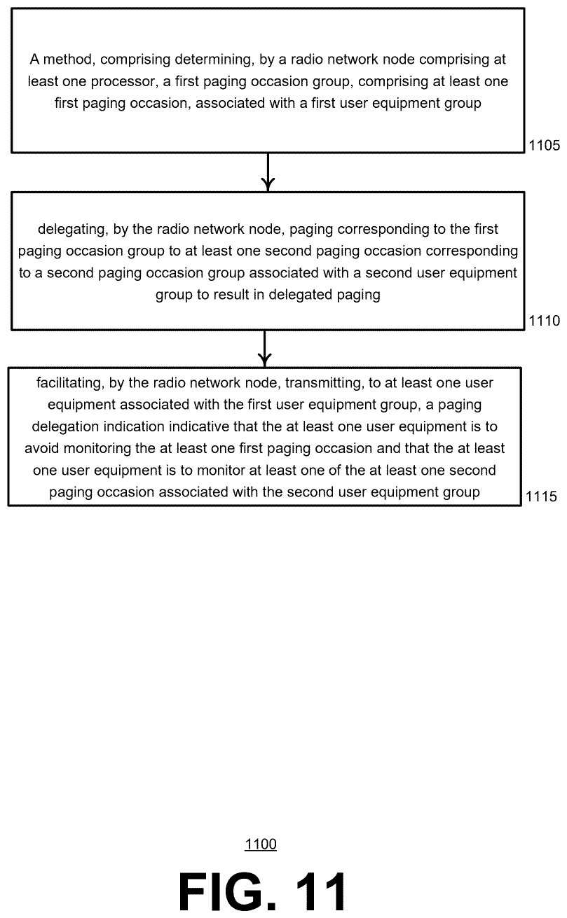

Turning now to FIG. 11, the figure illustrates an example embodiment method 1100 comprising at block 1105, determining, by a radio network node comprising at least one processor, a first paging occasion group, comprising at least one first paging occasion, associated with a first user equipment group; at block 1110 delegating, by the radio network node, paging corresponding to the first paging occasion group to at least one second paging occasion corresponding to a second paging occasion group associated with a second user equipment group to result in delegated paging; and at block 1115 facilitating, by the radio network node, transmitting, to at least one user equipment associated with the first user equipment group, a paging delegation indication indicative that the at least one user equipment is to avoid monitoring the at least one first paging occasion and that the at least one user equipment is to monitor at least one of the at least one second paging occasion associated with the second user equipment group.

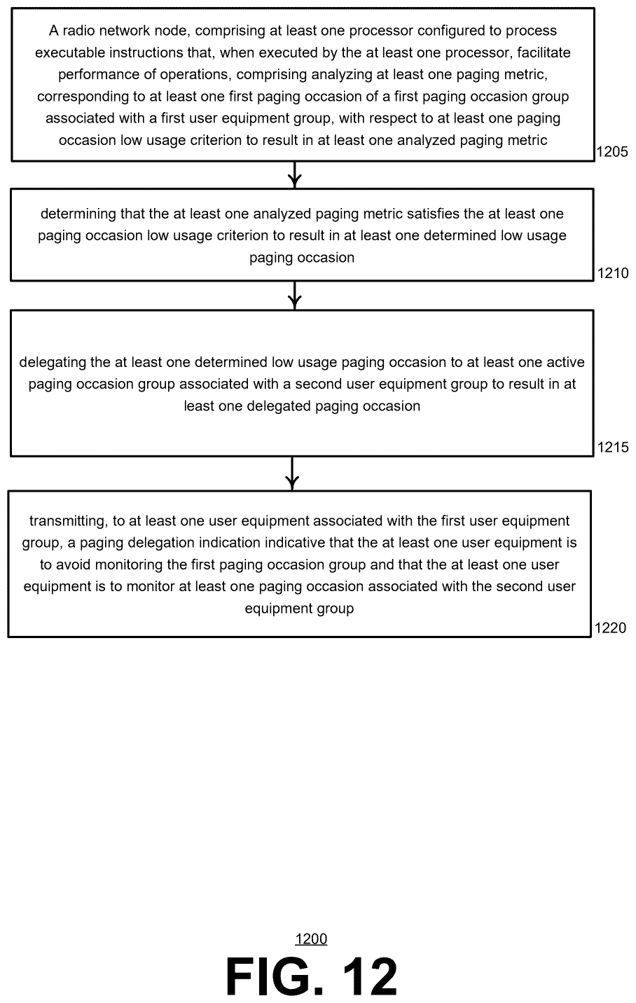

Turning now to FIG. 12, the figure illustrates a radio network node 1200, comprising at block 1205 at least one processor configured to process executable instructions that, when executed by the at least one processor, facilitate performance of operations, comprising analyzing at least one paging metric, corresponding to at least one first paging occasion of a first paging occasion group associated with a first user equipment group, with respect to at least one paging occasion low usage criterion to result in at least one analyzed paging metric; at block 1210 determining that the at least one analyzed paging metric satisfies the at least one paging occasion low usage criterion to result in at least one determined low usage paging occasion; at block 1215 delegating the at least one determined low usage paging occasion to at least one active paging occasion group associated with a second user equipment group to result in at least one delegated paging occasion; and at block 1220 transmitting, to at least one user equipment associated with the first user equipment group, a paging delegation indication indicative that the at least one user equipment is to avoid monitoring the first paging occasion group and that the at least one user equipment is to monitor at least one paging occasion associated with the second user equipment group.

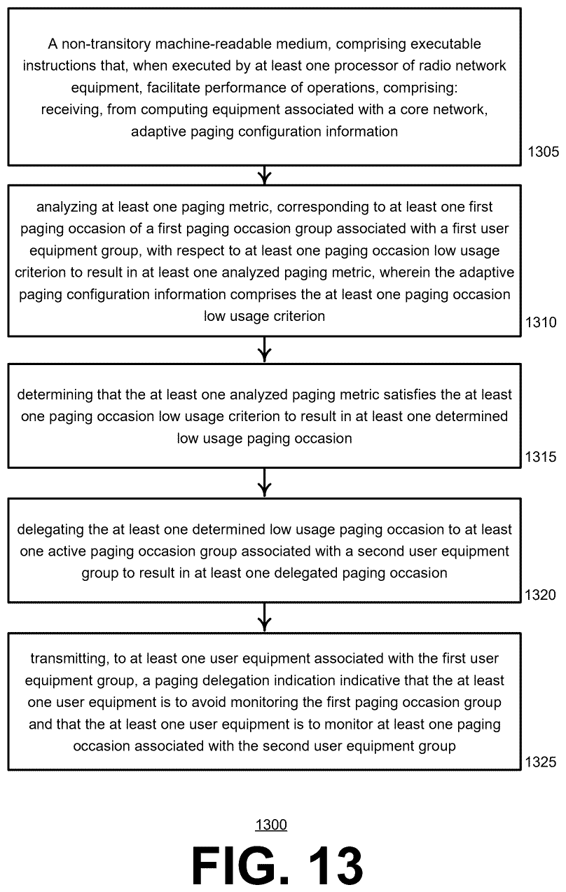

Turning now to FIG. 13 the figure illustrates a non-transitory machine-readable medium 1300 comprising at block 1305 executable instructions that, when executed by at least one processor of radio network equipment, facilitate performance of operations, comprising receiving, from computing equipment associated with a core network, adaptive paging configuration information; at block 1310 analyzing at least one paging metric, corresponding to at least one first paging occasion of a first paging occasion group associated with a first user equipment group, with respect to at least one paging occasion low usage criterion to result in at least one analyzed paging metric, wherein the adaptive paging configuration information comprises the at least one paging occasion low usage criterion; at block 1315 determining that the at least one analyzed paging metric satisfies the at least one paging occasion low usage criterion to result in at least one determined low usage paging occasion; at block 1320 delegating the at least one determined low usage paging occasion to at least one active paging occasion group associated with a second user equipment group to result in at least one delegated paging occasion; and at block 1325 transmitting, to at least one user equipment associated with the first user equipment group, a paging delegation indication indicative that the at least one user equipment is to avoid monitoring the first paging occasion group and that the at least one user equipment is to monitor at least one paging occasion associated with the second user equipment group.

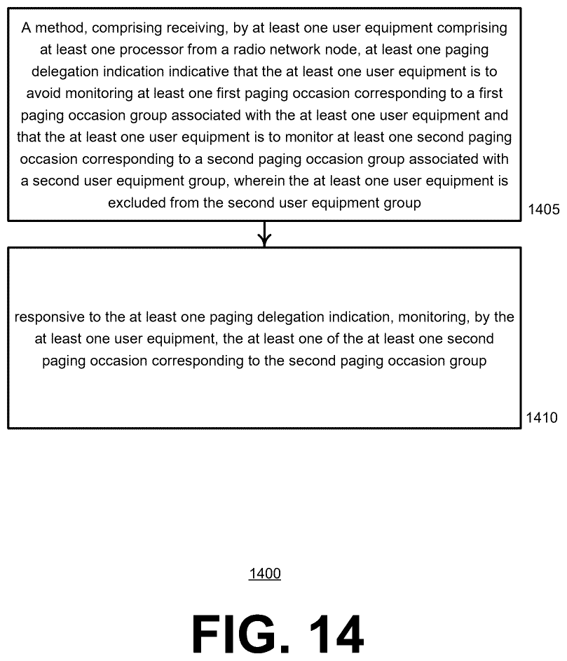

Turning now to FIG. 14, the figure illustrates an example embodiment method 1400 comprising, at block 1405, receiving, by at least one user equipment comprising at least one processor from a radio network node, at least one paging delegation indication indicative that the at least one user equipment is to avoid monitoring at least one first paging occasion corresponding to a first paging occasion group associated with the at least one user equipment and that the at least one user equipment is to monitor at least one second paging occasion corresponding to a second paging occasion group associated with a second user equipment group, wherein the at least one user equipment is excluded from the second user equipment group; and at block 1410 responsive to the at least one paging delegation indication, monitoring, by the at least one user equipment, the at least one of the at least one second paging occasion corresponding to the second paging occasion group.

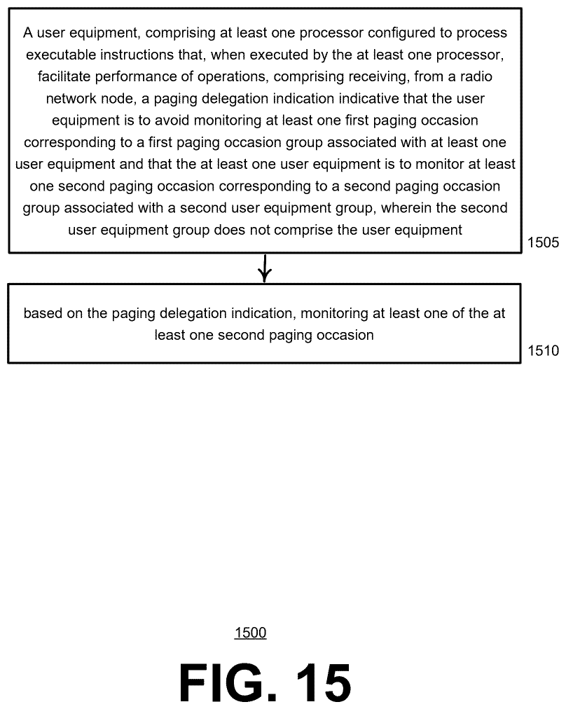

Turning now to FIG. 15, the figure illustrates an example user equipment 1500, comprising at block 1505 at least one processor configured to process executable instructions that, when executed by the at least one processor, facilitate performance of operations comprising receiving, from a radio network node, a paging delegation indication indicative that the user equipment is to avoid monitoring at least one first paging occasion corresponding to a first paging occasion group associated with at least one user equipment and that the at least one user equipment is to monitor at least one second paging occasion corresponding to a second paging occasion group associated with a second user equipment group, wherein the second user equipment group does not comprise the user equipment; and at block 1510 based on the paging delegation indication, monitoring at least one of the at least one second paging occasion.

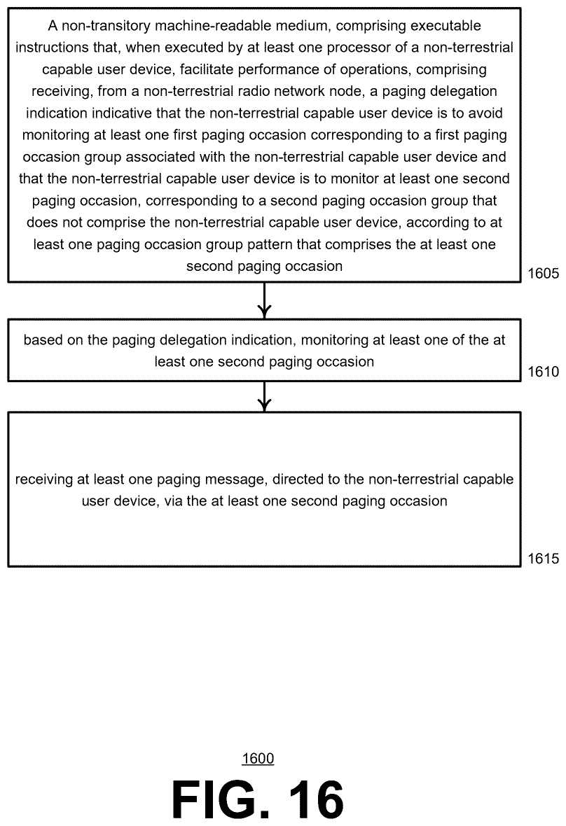

Turning now to FIG. 16, the figure illustrates a non-transitory machine-readable medium 1600 comprising at block 1605 executable instructions that, when executed by at least one processor of a non-terrestrial capable user device, facilitate performance of operations, comprising receiving, from a non-terrestrial radio network node, a paging delegation indication indicative that the non-terrestrial capable user device is to avoid monitoring at least one first paging occasion corresponding to a first paging occasion group associated with the non-terrestrial capable user device and that the non-terrestrial capable user device is to monitor at least one second paging occasion, corresponding to a second paging occasion group that does not comprise the non-terrestrial capable user device, according to at least one paging occasion group pattern that comprises the at least one second paging occasion; at block 1610 based on the paging delegation indication, monitoring at least one of the at least one second paging occasion; and at block 1615 receiving at least one paging message, directed to the non-terrestrial capable user device, via the at least one second paging occasion.

In order to provide additional context for various embodiments described herein, FIG. 17 and the following discussion are intended to provide a brief, general description of a suitable computing environment 1700 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors and may include a cache memory. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

Computer 1702 further includes an internal hard disk drive (HDD) 1714 (e.g., EIDE, SATA), one or more external storage devices 1716 (e.g., a magnetic floppy disk drive (FDD) 1716, a memory stick or flash drive reader, a memory card reader, etc.) and an optical disk drive 1720 (e.g., which can read or write from a CD-ROM disc, a DVD, a BD, etc.). While the internal HDD 1714 is illustrated as located within the computer 1702, the internal HDD 1714 can also be configured for external use in a suitable chassis (not shown). Additionally, while not shown in environment 1700, a solid-state drive (SSD) could be used in addition to, or in place of, an HDD 1714. The HDD 1714, external storage device(s) 1716 and optical disk drive 1720 can be connected to the system bus 1708 by an HDD interface 1724, an external storage interface 1726 and an optical drive interface 1728, respectively. The interface 1724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can comprise a security module, such as a trusted processing module (TPM). For instance, with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, etc.

A monitor 1746 or other type of display device can be also connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are example and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

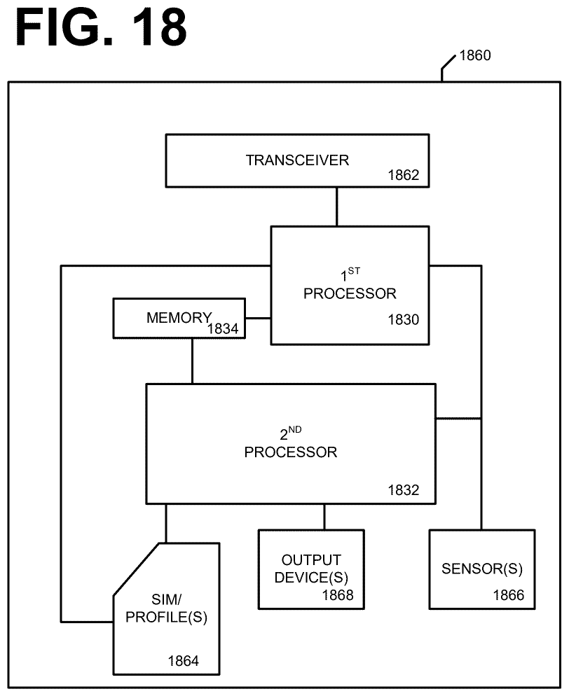

Turning to FIG. 18, the figure illustrates a block diagram of an example UE 1860. UE 1860 may comprise a smart phone, a wireless tablet, a laptop computer with wireless capability, a wearable device, a machine device that may facilitate vehicle telematics, a tracking device, remote sensing devices, and the like. UE 1860 comprises a first processor 1830, a second processor 1832, and a shared memory 1834. UE 1860 includes radio front end circuitry 1862, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 1862 may comprise multiple sets of circuitry or may be tunable to accommodate different frequency ranges, different modulations schemes, or different communication protocols, to facilitate long-range wireless links such as links 125, device-to-device links, such as links 135, and short-range wireless links, such as links 137.

Continuing with description of FIG. 18, UE 1860 may also include a SIM 1864, or a SIM profile, which may comprise information stored in a memory (memory 1834 or a separate memory portion), for facilitating wireless communication with RAN 105 or core network 130 shown in FIG. 1. FIG. 18 shows SIM 1864 as a single component in the shape of a conventional SIM card, but it will be appreciated that SIM 1864 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1864 and another device, which may be a component of RAN 105 or core network 130 shown in FIG. 1). A SIM profile 1864 may also comprise identifying information that is unique to the SIM, or SIM profile, such as, for example, an International Mobile Subscriber Identity (“IMSI”) or information that may make up an IMSI.

SIM 1864 is shown coupled to both the first processor portion 1830 and the second processor portion 1832. Such an implementation may provide an advantage that first processor portion 1830 may not need to request or receive information or data from SIM 1864 that second processor 1832 may request, thus eliminating the use of the first processor acting as a ‘go-between’ when the second processor uses information from the SIM in performing its functions and in executing applications. First processor 1830, which may be a modem processor or a baseband processor, is shown smaller than processor 1832, which may be a more sophisticated application processor, to visually indicate the relative levels of sophistication (i.e., processing capability and performance) and corresponding relative levels of operating power consumption levels between the two processor portions. Keeping the second processor portion 1832 asleep/inactive/in a low power state when UE 1860 does not need it for executing applications and processing data related to an application provides an advantage of reducing power consumption when the UE only needs to use the first processor portion 1830 while in listening mode for monitoring routine configured bearer management and mobility management/maintenance procedures, or for monitoring search spaces that the UE has been configured to monitor while the second processor portion remains inactive/asleep.

UE 1860 may also include sensors 1866, such as, for example, temperature sensors, accelerometers, gyroscopes, barometers, moisture sensors, and the like that may provide signals to the first processor 1830 or second processor 1832. Output devices 1868 may comprise, for example, one or more visual displays (e.g., computer monitors, VR appliances, and the like), acoustic transducers, such as speakers or microphones, vibration components, and the like. Output devices 1868 may comprise software that interfaces with output devices, for example, visual displays, speakers, microphones, touch sensation devices, smell or taste devices, and the like, that are external to UE 1860.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| AI | Artificial intelligence |
| ML | Machine learning |
| QCI | QoS Class Identifiers |
| BSR | Buffer status report |
| SBFD | Sub-band full duplex |
| CLI | Cross link interference |
| TDD | Time division duplexing |
| FDD | Frequency division duplexing |
| AI | Artificial intelligence |
| ML | Machine learning |
| MCS | Modulation and coding scheme |
| IE | Information element |
| BS | Base station |
| RRC | Radio resource control |
| UCI | Uplink control information |
| UE | User equipment |
| WTRU | Wireless transmit receive unit |
| CBR | Channel busy ratio |
| SCI | Sidelink control information |
| QoS | Quality of service |
| PER | Packet error rate |
| PDB | Packet delay budget |
| E2E | End to end |
| NES | Network energy saving |
| QCI | Quality class indication |
| RSRP | Reference signal received power |
| PCI | Primary cell ID |
| CSI-RS | Channel state information reference signals |
| PTRS | Phase tracking reference signals |
| DTX | Discontinuous transmission or discontinuous transmit |
| DRX | Discontinuous reception or discontinuous receive |
| CG | Configured grant |
| ULP | Uplink power |
| FBS | Fake base station |
| NTN | Non terrestrial network |
| gRAN | Ground radio access network |
| RAN | Radio access network |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by at least one user equipment comprising at least one processor from a radio network node, at least one paging delegation indication indicative that the at least one user equipment is to avoid monitoring at least one first paging occasion corresponding to a first paging occasion group associated with the at least one user equipment and that the at least one user equipment is to monitor at least one second paging occasion corresponding to a second paging occasion group associated with a second user equipment group, wherein the at least one user equipment is excluded from the second user equipment group; and
responsive to the at least one paging delegation indication, monitoring, by the at least one user equipment, the at least one of the at least one second paging occasion corresponding to the second paging occasion group.

2. The method of claim 1, wherein the at least one paging delegation indication is indicative of a delegation period during which the at least one user equipment is to monitor the at least one second paging occasion associated with the second user equipment group.

3. The method of claim 1, wherein the at least one paging delegation indication is transmitted via at least one downlink broadcast channel corresponding to the radio network node.

4. The method of claim 1, wherein the radio network node is a terrestrial radio network node.

5. The method of claim 1, wherein the radio network node is a non-terrestrial radio network node.

6. The method of claim 5, wherein the at least one user equipment is non-terrestrial capable.

7. The method of claim 1, wherein the at least one paging delegation indication comprises at least one paging occasion group pattern indication indicative of at least one paging occasion group pattern that comprises at least one of the at least one second paging occasion.

8. The method of claim 7, wherein the at least one paging occasion group pattern indication is indicative of a number of the at least one second paging occasion to avoid monitoring during a paging delegation period during which the at least one user equipment is to monitor the at least one second paging occasion.

9. The method of claim 1, further comprising:
receiving, by the at least one user equipment, at least one paging message, directed to the at least one user equipment, via the at least one second paging occasion.

10. The method of claim 9, further comprising:
determining, by the at least one user equipment, at least one paging detection reliability with respect to the at least one second paging occasion;
analyzing, by the at least one user equipment, the at least one paging detection reliability with respect to at least one paging detection criterion to result in at least one analyzed paging detection reliability; and
based on the at least one analyzed paging detection reliability being determined to violate the at least one paging detection criterion, transmitting, by the at least one user equipment to the radio network node, at least one detection sensitivity failure indication to be indicative to the radio network node that the at least one user equipment failed to detect or failed to decode the at least one paging message.

11. The method of claim 10, wherein the at least one detection sensitivity failure indication comprises at least one of: at least one device identifier associated with the at least one user equipment, or at least one failed-occasion indication indicative of the at least one second paging occasion with respect to which the at least one user equipment failed to detect or decode the at least one paging message.

12. A user equipment, comprising at least one processor configured to process executable instructions that, when executed by the at least one processor, facilitate performance of operations, comprising:
receiving, from a radio network node, a paging delegation indication indicative that the user equipment is to avoid monitoring at least one first paging occasion corresponding to a first paging occasion group associated with at least one user equipment and that the at least one user equipment is to monitor at least one second paging occasion corresponding to a second paging occasion group associated with a second user equipment group, wherein the second user equipment group does not comprise the user equipment; and
based on the paging delegation indication, monitoring at least one of the at least one second paging occasion.

13. The user equipment of claim 12, wherein the paging delegation indication is indicative of a delegation period during which the at least one user equipment is to monitor the at least one second paging occasion associated with the second user equipment group.

14. The user equipment of claim 13, wherein the delegation period is determined by the radio network node based on an energy parameter value corresponding to the radio network node.

15. The user equipment of claim 12, wherein the paging delegation indication comprises at least one paging occasion group pattern indication indicative of at least one paging occasion group pattern that comprises at least one of the at least one second paging occasion.

16. The user equipment of claim 12, wherein the operations further comprise:
determining at least one paging detection reliability with respect to the at least one second paging occasion, wherein the at least one paging detection reliability corresponds to a number of attempts to decode at least one paging message transmitted via the at least one of the at least one second paging occasion;
analyzing the at least one paging detection reliability with respect to at least one paging detection criterion to result in at least one analyzed paging detection reliability; and
based on the at least one analyzed paging detection reliability being determined to violate the at least one paging detection criterion, transmitting, by the at least one user equipment to the radio network node, at least one detection sensitivity failure indication to be indicative to the radio network node that the at least one user equipment failed to detect or failed to decode the at least one paging message.

17. The user equipment of claim 16, wherein at least one of the attempts to decode the at least one paging message comprises attempting to blindly decode the at least one paging message.

18. The user equipment of claim 12, wherein the operations further comprise:
receiving at least one paging message, directed to the user equipment, via the at least one second paging occasion.

19. A non-transitory machine-readable medium, comprising executable instructions that, when executed by at least one processor of a non-terrestrial capable user device, facilitate performance of operations, comprising:
receiving, from a non-terrestrial radio network node, a paging delegation indication indicative that the non-terrestrial capable user device is to avoid monitoring at least one first paging occasion corresponding to a first paging occasion group associated with the non-terrestrial capable user device and that the non-terrestrial capable user device is to monitor at least one second paging occasion, corresponding to a second paging occasion group that does not comprise the non-terrestrial capable user device, according to at least one paging occasion group pattern that comprises the at least one second paging occasion;
based on the paging delegation indication, monitoring at least one of the at least one second paging occasion; and
receiving at least one paging message, directed to the non-terrestrial capable user device, via the at least one second paging occasion.

20. The non-transitory machine-readable medium of claim 19, wherein the operations further comprise:
determining at least one paging detection reliability with respect to the at least one second paging occasion, wherein the at least one paging detection reliability corresponds to a number of attempts to blindly decode at least one paging message transmitted via the at least one of the at least one second paging occasion;
analyzing the at least one paging detection reliability with respect to at least one paging detection criterion to result in at least one analyzed paging detection reliability; and
based on the at least one analyzed paging detection reliability being determined to violate the at least one paging detection criterion, transmitting, by the at least one non-terrestrial capable user device to the non-terrestrial radio network node, at least one detection sensitivity failure indication to be indicative to the non-terrestrial radio network node to change the at least one paging occasion group pattern.
